(19) United States
(12) Patent Application Publication
(10) Pub. No.: US 2014/0274423 A1
(43) Pub. Date: Sep. 18, 2014

(54) VEHICLE STEERING SYSTEM TORSION BAR

(71) Applicant: HB Performance Systems, Inc., Mequon, WI (US)

(72) Inventors: Tim Osterberg, Mequon, WI (US); Rod Weekley, Mequon, WI (US); Patrick Schwobe, Mequon, WI (US)

(73) Assignee: HB Performance Systems, Inc., Mequon, WI (US)

(21) Appl. No.: 14/211,896

(22) Filed: Mar. 14, 2014

Related U.S. Application Data
(60) Provisional application No. 61/794,861, filed on Mar. 15, 2013.

(51) Int. Cl. B62D 3/02

(52) U.S. Cl. CPC B62D 3/02
USPC 464/97

(57) ABSTRACT

A vehicle steering assembly comprising an input member, an output member, and a torsion bar coupling the input member to the output member. The torsion bar includes primary and secondary load structures, and the secondary load structure is inoperative below a transition torque. The primary load structure includes a primary torque member that constantly couples the input member to the output member throughout an operative range of the steering assembly. The secondary load structure includes first and second torque members that are separated by a gap when the assembly encounters a torque below the transition torque and that contact each other when the assembly encounters a torque above the transition torque. The first torque member can comprise a tubular structure surrounding the primary torque member. The tubular structure includes an opening defining a circumferentially-exposed surface, and the second torque member includes a radially-extending arm positioned in the opening.

### BACKGROUND

The present invention generally relates to torsion bars for power steering systems that use steer torque input as a parameter in controlling steering assistance.

Power steering systems commonly use the level of user input as a parameter for determining the amount of steering assistance to be provided by the system. One measure of user input is the amount of torque in the system. There are various means for measuring steering torque

### SUMMARY

The present invention provides a vehicle steering assembly comprising an input member mounted for rotation, an output member mounted for rotation, and a torsion bar coupling the input member to the output member. The torsion bar includes a primary load structure and a secondary load structure, and the secondary load structure is inoperative below a transition torque. The primary load structure is preferably operative from zero torque to the transition torque.

In one embodiment, the primary load structure includes a primary torque member that constantly couples the input member to the output member throughout an operative range of the steering assembly. Preferably, the secondary load structure includes first and second torque members that are separated by a gap when the vehicle steering assembly encounters a torque below the transition torque and that contact each other when the vehicle steering assembly encounters a torque above the transition torque. For example, the first torque member can include a circumferentially-exposed surface, and the second torque member can include a radially-extending arm positioned to contact the circumferentially-exposed surface when the transition torque is exceeded. Preferably, the first torque member comprises a tubular structure surrounding the primary torque member, the tubular structure includes an opening (e.g., a plurality of openings) defining the circumferentially-exposed surface, and the radially-extending arm (e.g., a plurality of radially-extending arms) is positioned in the opening.

The torsion bar can further include a first shaft secured to a first end of the primary torque member and to the first torque member, and a second shaft secured to a second end of the primary torque member and to the second torque member. For example, the first torque member can be secured to the first shaft adjacent the first end of the primary torque member, and the second torque member can extend radially from the second shaft adjacent the second end of the primary torque member.

Other aspects of the invention will become apparent by consideration of the detailed description and accompanying drawings.

### BRIEF DESCRIPTION OF THE DRAWINGS

FIG. 1 illustrates an All Terrain Vehicle (ATV) having a steering system embodying the present invention.

FIG. 2 is a schematic sketch of a torsion bar embodying the present invention.

FIG. 3 illustrates another embodiment of the invention using two arms with clearance holes encompassing via designed contact clearance an undersized crossbar to provide the secondary stop and load path function.

FIG. 4 is yet another embodiment of the invention using a “birdcage” type surround outside of the torsional element to provide progressive rotary stops and secondary redundant load path function.

FIG. 5 is a longitudinal section view of the embodiment of FIG. 4.

FIG. 6 is a photograph of the integrated “birdcage” embodiment of FIG. 4 including a sensor assembly.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

FIG. 1 illustrates an ATV 10 having wheels 12, a seat 14, and handlebars 16 for steering the ATV 10. The concept of the present invention can be applied to a variety of different vehicles, such as UTVs and snowmobiles.

FIG. 2 provides a cross section sketch of one embodiment of this invention. The invention is intended to combine the function of a tradition T-bar steer torque insulator or torque measurement assembly and to also preserve a second load path for translation of steering actions in the event of any loss or reduced function of the more flexible torsion bar spring element. The torsional element in the assembly would typically be designed for expected life of vehicle use however the addition of a second redundant load path may be required or viewed as an appropriate way to further enhance the design robustness of a steering system.

FIG. 3 depicts an embodiment of the invention where two arms 11 extend parallel to the torsional spring from one end of the torsion spring bar 12 to the other and further surround an interface with a cross bar 16 via a designed clearance fit between the cross bar 16 and clearance holes (not shown) in the forward portion of the arms 11. During light load twisting of the torsion bar element, the arms 11 rotate with the base end 18 of the torsion bar and the clearance between the holes on the arms 11 and the cross bar 16 varies. As torsion loading increases and relative resultant deflection increases, the cross bar 16 twists relative to the arms 11 and will reach a degree of twist condition relative to the holes in the forward part of the arms 11 where contact will occur between the cross bar 16 and the wall of the holes in the arms 11 to share the increasing torsional load with progressively more torque being carried by the contact interface between the cross bar 16 and the arms 11 thus establishing a second torsional load path. Sizing of the components and the relative stiffness or spring rates of the second load path geometry can enable progressive sharing or complete translation of the operational steering torque as needed to meet the requirement of various applications.

FIG. 4 and FIG. 5 depict an embodiment of the invention that uses “birdcage” type geometry as to enable the secondary load path. In this example, a torsion bar 20 couples an input member of the steering assembly to an output member of the steering assembly. The torsion bar 20 includes a first shaft 22, a second shaft 24, a primary load structure defining the primary load path, and a secondary load structure defining the secondary load path. The primary load structure is always operative between the first and second shafts, and the secondary load structure is designed to only be operative above a transition torque.

The primary load structure includes a primary torque member 26 that constantly couples the first and second shafts 22,24 throughout an operative range of the steering assembly. The primary torque member 26 includes a first end 28 secured to the first shaft 22 and a second end 30 secured to the second shaft 24.

The secondary load structure includes first and second torque members that are separated by a gap when the vehicle steering assembly encounters a torque below the transition torque and that contact each other when the vehicle steering assembly encounters a torque above a transition torque. The first torque member comprises a tubular structure 32 secured to the first shaft 22 adjacent the first end 28 of the primary torque member 26. The tubular structure 32 surrounds the primary torque member 26. The tubular structure 32 includes four openings 34, each defining circumferentially-exposed surfaces 36.

The second torque member comprises four radially-extending arms 38 secured to the second shaft 24 adjacent the end 30 of the primary torque member 26. Each arm 38 is positioned in a corresponding opening 34 in the tubular structure 32 and is designed to contact the circumferentially-exposed surfaces 36 of the tubular structure 32 when a transition torque is exceeded.

The torsional load is transferred progressively into the tubular structure 32 after the torsional bar 20 has twisted to the point where the arms 38 begin to contact the tubular structure 32. Tuning of the progressive spring rate of the mechanism would be accomplished by staging the stiffness of the radially-extending arms 38 and the tubular structure 32 and the timing of when the arms 38 would make contact with the tubular structure 32. For example the primary torque member 26 could provide an initial torsional spring rate for the mechanism. After a specified range of twist, one pair of the arms 38 (preferably opposing arms) could make initial contact with the tubular structure 32, and then be followed by a second pair of arms 38 to create progressive spring rates through the torsion bar 20 operational range.

FIG. 6 is a picture of the above concept functionally integrated into a steering shaft component and combined with a commercial steering position sensor 40 that measures the relative twist of the torsion bar mechanism to calculate a relative measurement of torsional force transmitted through the invention.

1. A vehicle steering assembly comprising:
an input member mounted for rotation;
an output member mounted for rotation; and
a torsion bar coupling the input member to the output member, the torsion bar including a primary load structure and a secondary load structure, the secondary load structure being inoperative below a transition torque.

2. A vehicle steering assembly as claimed in claim 1, wherein the primary load structure is operative from zero torque to the transition torque.

3. A vehicle steering assembly as claimed in claim 1, wherein the primary load structure includes a primary torque member that constantly couples the input member to the output member throughout an operative range of the steering assembly.

4. A vehicle steering assembly as claimed in claim 3, wherein the secondary load structure includes first and second torque members that are separated by a gap when the vehicle steering assembly encounters a torque below the transition torque and that contact each other when the vehicle steering assembly encounters a torque above the transition torque.

5. A vehicle steering assembly as claimed in claim 4, wherein the first torque member comprises a circumferentially-exposed surface, and wherein the second torque member comprises a radially-extending arm positioned to contact the circumferentially-exposed surface when the transition torque is exceeded.

6. A vehicle steering assembly as claimed in claim 5, wherein the first torque member comprises a tubular structure surrounding the primary torque member, wherein the tubular structure include an opening defining the circumferentially-exposed surface, and wherein the radially-extending arm is positioned in the opening.

7. A vehicle steering assembly as claimed in claim 6, wherein the tubular structure includes a plurality of openings and the second torque member comprises a plurality of radially-extending arms, each positioned in one of the plurality of openings.

8. A vehicle steering assembly as claimed in claim 4, wherein the torsion bar further includes:
a first shaft secured to a first end of the primary torque member and to the first torque member; and
a second shaft secured to a second end of the primary torque member and to the second torque member.

9. A vehicle steering assembly as claimed in claim 8, wherein the first torque member is secured to the first shaft adjacent the first end of the primary torque member.

10. A vehicle steering assembly as claimed in claim 9, wherein the second torque member extends radially from the second shaft adjacent the second end of the primary torque member.
